(19) United States
(12) Patent Application Publication
(10) Pub. No.: US 2015/0311767 A1
(43) Pub. Date: Oct. 29, 2015

(54) MOTOR

(71) Applicant: EPF Hobby Co., Ltd., Taichung City (TW)

(72) Inventor: Kuo-Cheng Huang, Taichung City (TW)

(73) Assignee: EPF Hobby Co., Ltd., Taichung City (TW)

(21) Appl. No.: 14/263,300

(22) Filed: Apr. 28, 2014

(51) Int. Cl. H02K 5/16

(52) U.S. Cl. CPC H02K 5/161

(57) ABSTRACT

A motor includes a stator unit, a rotor unit, and an anti-friction bearing unit. The stator unit includes a coil winding assembly. The rotor unit includes a permanent magnet assembly disposed to radially confront the coil winding assembly, and is rotatable relative to the stator unit as a result of electromagnetic forces acting between the permanent magnet assembly and the coil winding assembly. The anti-friction bearing unit is disposed between the stator and rotor units so as to stabilize rotation of the rotor unit.

### BACKGROUND OF THE INVENTION

1. Field of the Invention

This invention relates to a motor, more particularly to a motor with an anti-friction bearing.

2. Description of the Related Art

With reference to FIGS. 1 and 2, a conventional motor 1 used in a model aircraft or a model ship includes a stator unit 11 and a rotor unit 12.

The stator unit 11 includes a base mount 111, a tubular shaft 114 extending from the base mount 111 and having an axial hole 113 which extends along a shaft axis (A), and a coil winding assembly 112 sleeved on the tubular shaft 114.

The rotor unit 12 includes a rotor housing 122 for mounting of a propeller (not shown) thereon, a spindle 121 extending from the rotor housing 122 into the axial hole 113, and a permanent magnet assembly 123 disposed on an inner surface of the rotor housing 122 to confront the coil winding assembly 112. The rotor unit 12 can rotate relative to the stator unit 11 as a result of electromagnetic forces acting between the permanent magnet assembly 123 and the coil winding assembly 122.

If the elements of the conventional motor 1 have size deviations, shifting of a center of gravity of the motor may result. In this case, a rotation center of the rotor unit 12 may shift from the axis (A), resulting in abrasion between the stator and rotor units 11, 12, which may adversely affect the structure and/or the operation of the motor 1.

### SUMMARY OF THE INVENTION

Therefore, an object of the present invention is to provide a motor including an anti-friction bearing. With the arrangement of the anti-friction bearing, abrasion between stator and rotor units can be greatly reduced so as to stabilize rotation of the rotor unit.

Accordingly, a motor of this invention includes a stator unit, a rotor unit, and an anti-friction bearing unit.

The stator unit includes a base mount having a central area and a marginal area surrounding the central area, a tubular shaft extending from the central area and having an axial hole along a shaft axis, and a coil winding assembly sleeved on the tubular shaft.

The rotor unit includes a carrier top, a spindle, a carrier surrounding wall, and a permanent magnet assembly. The carrier top has a center region and a peripheral region surrounding the center region. The spindle extends from the center region and is configured to be inserted into the axial hole along the shaft axis and to be rotatable relative to the tubular shaft. The carrier surrounding wall extends from the peripheral region to terminate at a wall end, and has an inner surrounding surface which has a major surrounding region and a marginal surrounding region distal from and proximate to the wall end, respectively. The marginal surrounding region is spaced apart from the coil winding assembly in radial directions to define an annular space therebetween. The permanent magnet assembly is disposed on the major surrounding region to radially confront the coil winding assembly such that the rotor unit is permitted to rotate relative to the stator unit as a result of electromagnetic forces acting between the permanent magnet assembly and the coil winding assembly.

The anti-friction bearing unit is disposed in the annular space, and has a plurality of bearings, each of which includes an outer race configured to rotate with the carrier surrounding wall.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded elevation view of a conventional motor;

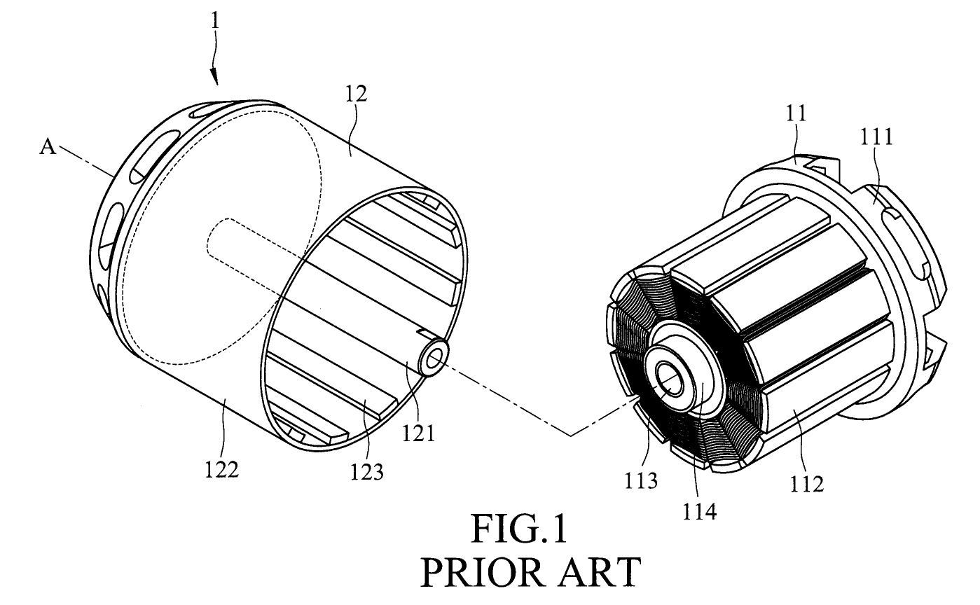

FIG. 2 is a side view of FIG. 1;

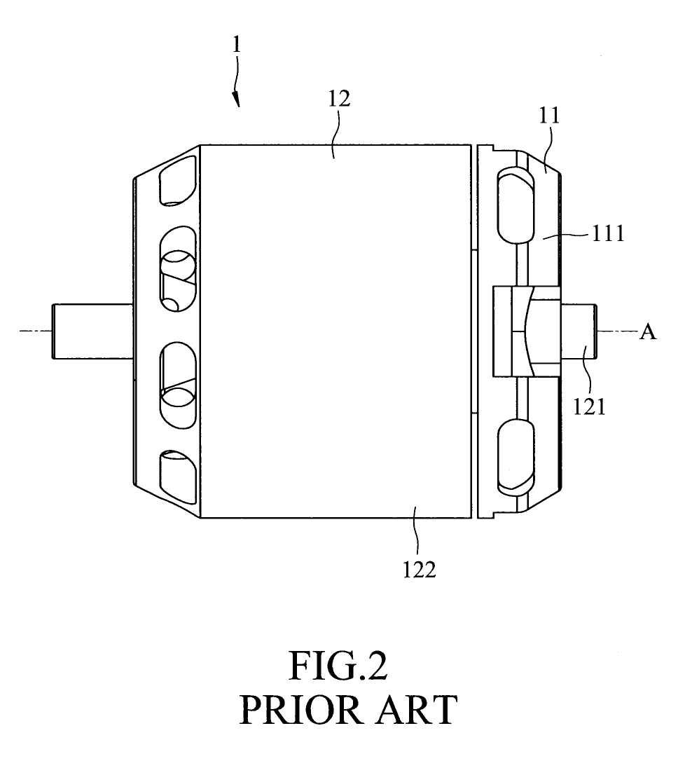

FIG. 3 is an exploded elevation view of a motor according to a first preferred embodiment of this invention;

FIG. 4 is a side view of FIG. 3;

FIG. 5 is a fragmentary enlarged cross-sectional view of FIG. 3;

FIG. 6 is a schematic view illustrating a position of an anti-friction bearing between stator and rotor units of the motor according to the first preferred embodiment of this invention;

FIG. 7 is a fragmentary enlarged cross-sectional view of a motor according to a second preferred embodiment of this invention; and

FIG. 8 is a schematic view illustrating a position of an anti-friction bearing between stator and rotor units of the motor according to the second preferred embodiment of this invention.

### DETAILED DESCRIPTION OF THE PREFERRED EMBODIMENTS

Before the present invention is described in greater detail, it should be noted herein that same reference numerals are used to denote like elements throughout the specification.

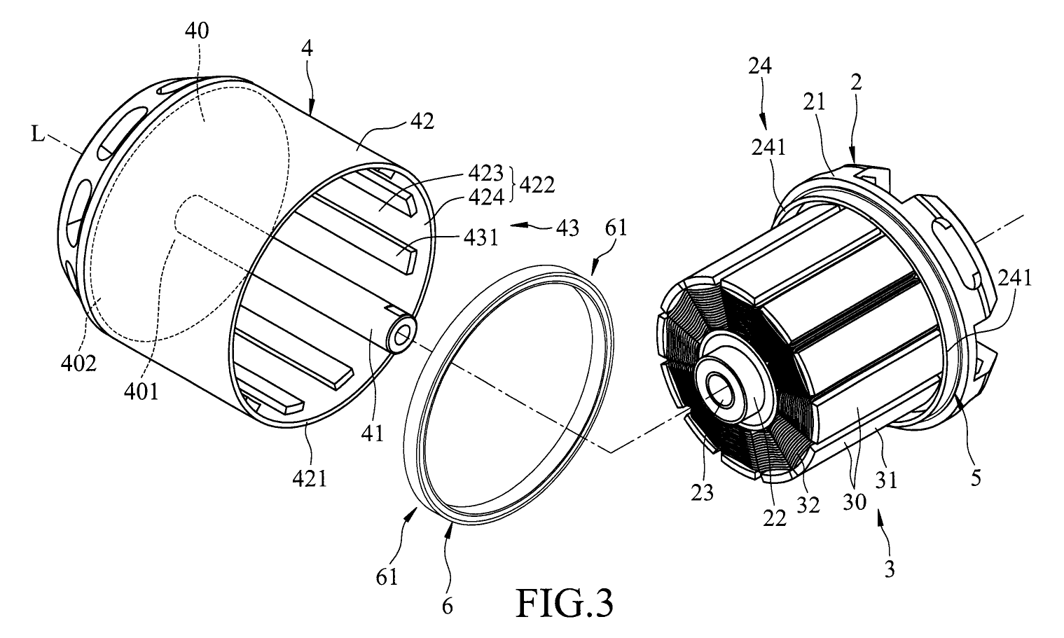

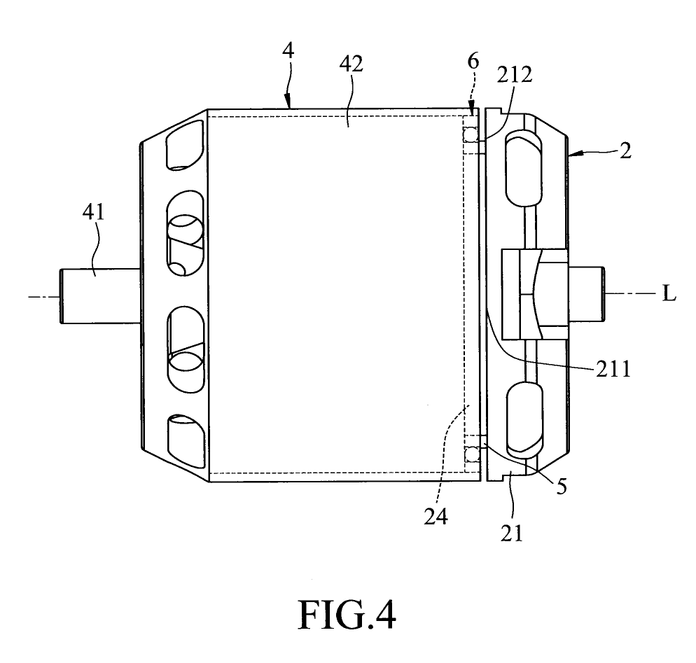

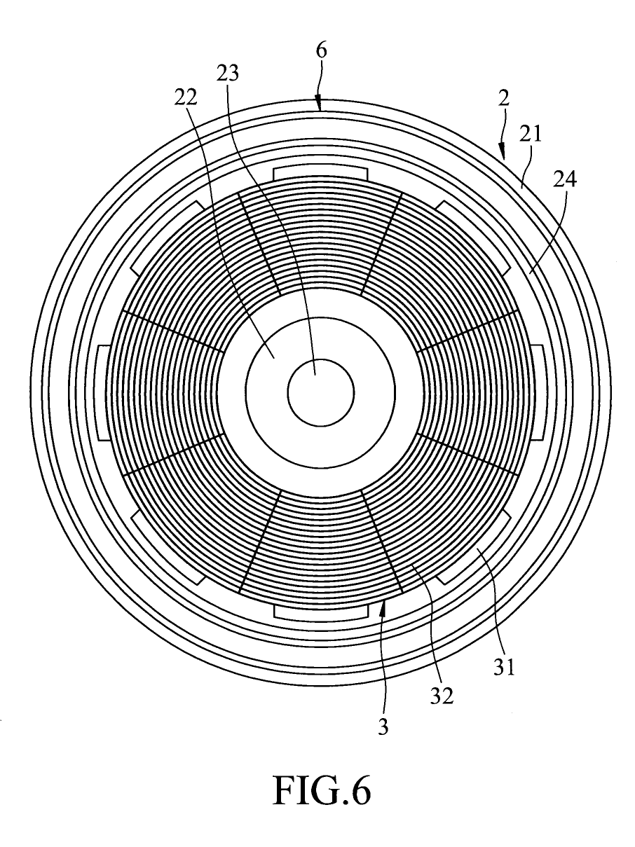

Referring to FIGS. 3 to 6, a motor adapted for use in a model aircraft or a model ship according to a first preferred embodiment of this invention is shown to include a stator unit 2, a rotor unit 4, and an anti-friction bearing unit 6.

The stator unit 2 includes a base mount 21, a tubular shaft 22, and a coil winding assembly 3. The base mount 21 has a central area 211 and a marginal area 212 surrounding the central area 211. The tubular shaft 22 extends from the central area 211 and has an axial hole 23 along a shaft axis (L). The coil winding assembly 3 is sleeved on the tubular shaft 22, and includes a plurality of coil winding units 30 displaced from one another in a circumferential direction. Each of the coil winding units 30 includes a silicon steel member 31 and a coil member 32 wound on the silicon steel member 31.

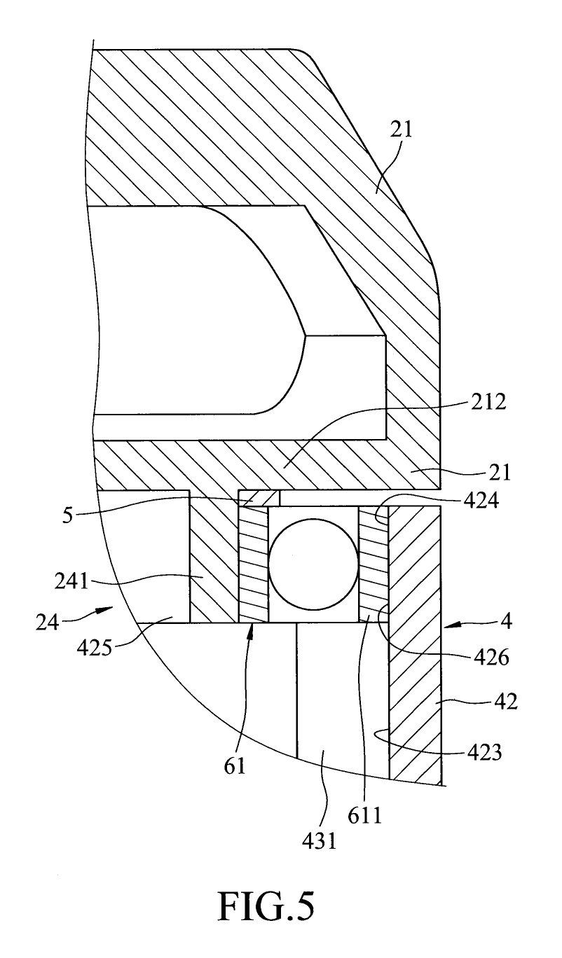

The rotor unit 4 is configured for mounting of a propeller (not shown) thereon, and includes a carrier top 40, a spindle 41, a carrier surrounding wall 42, and a permanent magnet assembly 43. The carrier top 40 has a center region 401 and a peripheral region 402 surrounding the center region 401. The spindle 41 extends from the center region 401, and is configured to be inserted into the axial hole 23 along the shaft axis (L) and to be rotatable relative to the tubular shaft 22. The carrier surrounding wall 42 extends from the peripheral region 402 to terminate at a wall end 421, and has an inner surrounding surface 422 which has a major surrounding region 423 and a marginal surrounding region 424 distal from and proximate to the wall end 421, respectively. The marginal surrounding region 424 is spaced apart from the coil winding assembly 3 in radial directions to define therebetween an annular space 425 (see FIG. 5). The permanent magnet assembly 43 is disposed on the major surrounding region 423 to radially confront the coil winding assembly 3 such that the rotor unit 4 is permitted to rotate relative to the stator unit 2 as a result of electromagnetic forces acting between the permanent magnet assembly 43 and the coil winding assembly 3. In this embodiment, the permanent magnet assembly 43 includes a plurality of permanent magnets 431 displaced from one another in the circumferential direction.

The anti-friction bearing unit 6 is disposed in the annular space 425 and has a plurality of bearings 61. Each of the bearings 61 includes an outer race 611 configured to rotate with the carrier surrounding wall (see FIG. 5). Due to the provision of the anti-friction bearing unit 6, the structure of the motor can be reinforced, and the rotation of the rotor unit 4 can be stabilized to allow the rotor unit 4 to rotate at a relatively high speed.

In this embodiment, the bearings 61 each extend in the circumferential direction, and are connected to one another in the circumferential direction to form a one-piece annular construction. Preferably, the anti-friction bearing unit 6 is a ball bearing.

The stator unit 2 further includes an abutment member 24 including a plurality of abutment segments 241 which extend from the marginal area 212 into the annular space 425, and which are displaced from one another circumferentially about the shaft axis (L). The abutment member 24 and the marginal surrounding region 424 cooperatively define a surrounding gap 426 therebetween, and the anti-friction bearing unit 6 is fittingly inserted in the surrounding gap 426 to permit the outer race 611 of each of the bearings 61 to rotate about the shaft axis (L).

In this embodiment, the abutment segments 241 each extend in the circumferential direction and are connected to each other in the circumferential direction to form a one-piece annular construction.

Preferably, the motor further includes a retaining ring 5 disposed outwardly of the abutment member 24 and between the marginal area 212 and the anti-friction bearing 6.

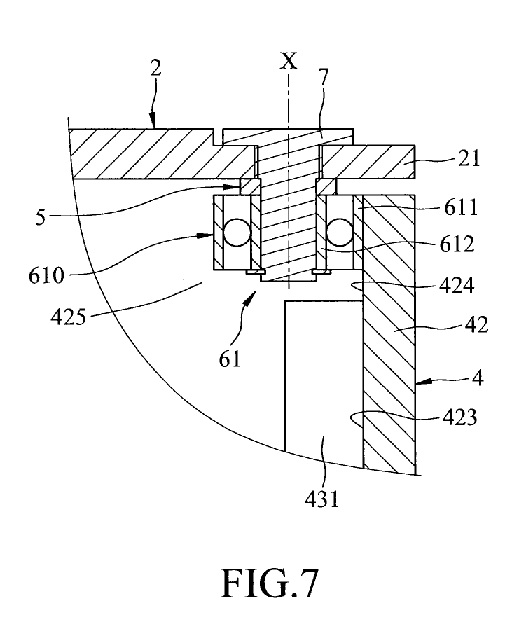

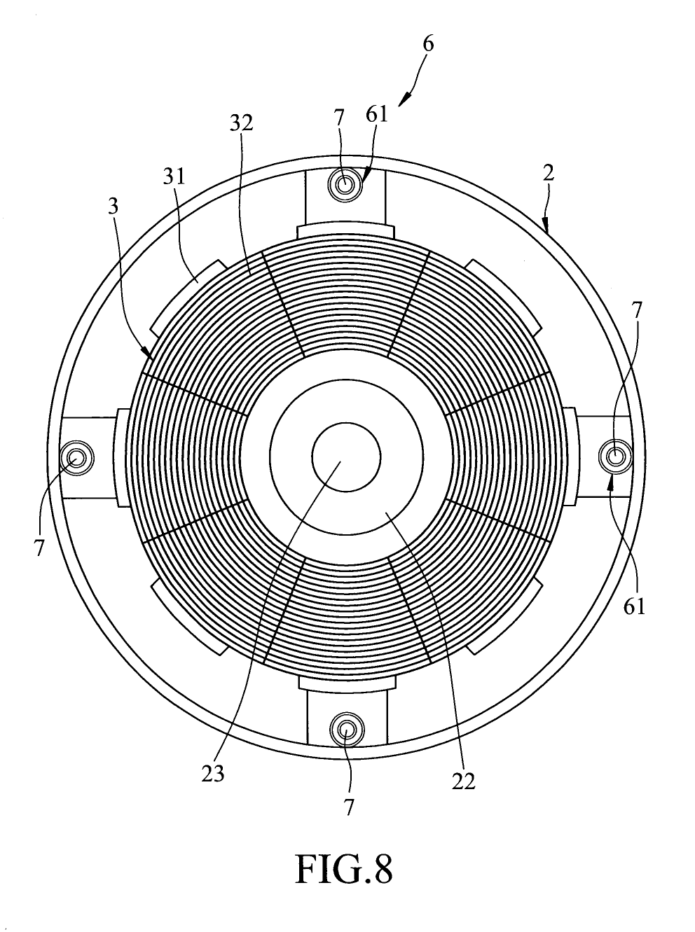

FIGS. 7 and 8 illustrate a motor according to a second preferred embodiment of this invention. The second preferred embodiment is similar to the first preferred embodiment, except that, in the second preferred embodiment, the abutment member 24 is omitted, and each of the bearings 61 includes a mounting post 7 extending in a post axis (X) parallel to the shaft axis (L), and a bearing body 610 surrounding the mounting post 7. The bearing body 610 includes an outer race 611 and an inner race 612 that respectively extend about the post axis (X). The outer race 611 is configured to rotate about the post axis (X) when rotating with the carrier surrounding wall 42. In this embodiment, the bearing body 610 is a ball bearing.

Preferably, the mounting post 7 is configured to be threadedly engageable with the base mount 21. Thus, the anti-friction bearing unit 6 can be easily installed on the base mount 21.

In this embodiment, the motor further includes a plurality of retaining rings 5 each of which is sleeved on the mounting post 7 of a corresponding one of the bearings 61, and is disposed between the base mount 21 and the bearing body 610 of the corresponding one of the bearings 61.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A motor comprising:
a stator unit including,
a base mount having a central area and a marginal area surrounding said central area,
a tubular shaft extending from said central area and having an axial hole along a shaft axis, and
a coil winding assembly sleeved on said tubular shaft;
a rotor unit including,
a carrier top having a center region and a peripheral region surrounding said center region,
a spindle extending from said center region and configured to be inserted into said axial hole along the shaft axis and to be rotatable relative to said tubular shaft,
a carrier surrounding wall extending from said peripheral region to terminate at a wall end, and having an inner surrounding surface which has a major surrounding region and a marginal surrounding region distal from and proximate to said wall end, respectively, said marginal surrounding region being spaced apart from said coil winding assembly in radial directions to define an annular space therebetween, and
a permanent magnet assembly disposed on said major surrounding region to radially confront said coil winding assembly such that said rotor unit is permitted to rotate relative to said stator unit as a result of electromagnetic forces acting between said permanent magnet assembly and said coil winding assembly; and
an anti-friction bearing unit disposed in said annular space, and having a plurality of bearings, each of which includes an outer race configured to rotate with said carrier surrounding wall.

2. The motor of claim 1, wherein said stator unit further includes an abutment member including a plurality of abutment segments which extend from said marginal area into said annular space, and which are displaced from one another circumferentially about the shaft axis, said bearings each extending in a circumferential direction and being connected to one another to form a one-piece annular construction, said abutment member and said marginal surrounding region cooperatively defining a surrounding gap therebetween, said anti-friction bearing unit being fittingly inserted in said surrounding gap to permit said outer race to rotate about the shaft axis.

3. The motor of claim 2, wherein said abutment segments each extend in the circumferential direction and are connected to each other in the circumferential direction to form a one-piece annular construction.

4. The motor of claim 1, wherein each of said bearings includes a mounting post extending in a post axis parallel to the shaft axis, and a bearing body which surrounds said mounting post, and which includes said outer race and an inner race that respectively extend about the post axis, said outer race being configured to rotate about the post axis when rotating with said carrier surrounding wall.

5. The motor of claim 4, wherein said mounting post is configured to be threadedly engageable with said base mount.

6. The motor of claim 2, further comprising a retaining ring disposed outwardly of said abutment member and between said marginal area and said anti-friction bearing.

7. The motor of claim 4, further comprising a plurality of retaining rings each of which is sleeved on said mounting post of a corresponding one of said bearings and is disposed between said base mount and said bearing body of the corresponding one of said bearings.
